(19) United States
(12) Patent Application Publication
(10) Pub. No.: US 2025/0389305 A1
(43) Pub. Date: Dec. 25, 2025

(54) ACTUATOR PRIMARILY ACTIVATED BY TRANSVERSAL ACCELERATION

(71) Applicant: Brillianze Sweden AB, Svedala (SE)

(72) Inventors: Patrik Zander, Svedala (SE); Stig Jonny Holmberg, Svedala (SE)

(21) Appl. No.: 18/880,453

(22) PCT Filed: Jul. 4, 2023
(86) PCT No.: PCT/SE2023/050696

§ 371 Date: Dec. 31, 2024

(30) Foreign Application Priority Data
Jul. 5, 2022 (SE) 2250846-9

(51) Int. Cl. F16D 59/00; F16D 43/20; F16D 127/00; F16D 127/02

(52) U.S. Cl. CPC F16D 59/00; F16D 43/20; F16D 2127/005; F16D 2127/02

(57) ABSTRACT

An actuator for coupling to a rotatable object, the actuator being configured to be primarily activated by Euler forces arising from rotational acceleration of the rotatable object about an object pivot point of the rotatable object, the actuator comprising a first coupling arrangement and second coupling arrangement, each coupling arrangement being configured to be pivotally coupled to the rotatable object by a respective coupling arrangement pivot point, wherein each coupling arrangement comprises a first outer pivot point and a second outer pivot point radially offset from the coupling arrangement pivot point, wherein the respective first outer pivot points are operatively coupled by a first body, and the respective second outer pivot points are operatively coupled by a second body, such that a center of mass of each body is radially offset from the object pivot point when the actuator is coupled to the rotatable object.

### CROSS REFERENCE TO RELATED APPLICATIONS

This application is a national stage entry of International Patent Application No. PCT/SE2023/050696, filed 4 Jul. 2023, which claims the benefit of SE Patent Application No. 2250846-9, filed 5 Jul. 2022, the entire content of each application is incorporated herein by reference.

### TECHNICAL FIELD

The present disclosure relates to an acceleration activated actuator and more particularly to an actuator for coupling to a rotatable object, primarily activated by transversal acceleration arising from rotational acceleration of a rotatable object.

### BACKGROUND

The rotation of a body may be described using numerous parameters and a commonly used parameter is the angular velocity. The rotation will give rise to a centrifugal force that is dependent on the angular velocity of the rotating body. The centrifugal force is a phenomena that is commonly utilized when engineering e.g. brakes or clutches. These devices are commonplace but have at least one inherent flaw. Devices actuated by the centrifugal force will typically activate when the rotation of the body exceeds a certain angular velocity. This is useful in some applications, but many applications require devices that activate by angular acceleration rather than velocity. These devices will activate already in response to changes in angular velocity and are preferably independent of the angular velocity.

One such device is disclosed in WO 2017140734 in the form of a rotational friction brake regulated by the rate of change of the angular speed. The rotational friction brake comprises a first body and a second body rotationally attached to the first body.

One shortcoming of the prior art is that applications may be limited due to the design of the actuating parts of the device. The actuating parts may for instance require lots of space or a certain position in the device.

From the above it is understood that there is room for improvements.

### SUMMARY

An object of the present disclosure is to provide a new type of activator for activation by acceleration which is improved over prior art and which eliminates or at least mitigates the drawbacks discussed above. More specifically, an object of the disclosure is to provide an actuator configured to be primarily activated by transversal force arising from rotational acceleration. This object is achieved by the technique set forth in the appended independent claims with preferred embodiments defined in the dependent claims related thereto.

In a first aspect, an actuator for coupling to a rotatable object is presented. The actuator is configured to be primarily activated by Euler forces arising from rotational acceleration of the rotatable object about an object pivot point of the rotatable object. The actuator comprises a first coupling arrangement and second coupling arrangement, each coupling arrangement being configured to be pivotally coupled to the rotatable object by a respective coupling arrangement pivot point. Each coupling arrangement comprises a first outer pivot point and a second outer pivot point radially offset from the coupling arrangement pivot point. The respective first outer pivot points are operatively coupled by a first body, and the respective second outer pivot points are operatively coupled by a second body, such that a center of mass of each body is radially offset from the object pivot point when the actuator is coupled to the rotatable object.

In one embodiment of the actuator, due to said non-uniform mass distribution about the object pivot point, the actuator is configured to transition to an activated state, by said first and second bodies rotating about the object pivot point, in response to rotational acceleration of the object exceeding a predefined or configurable first threshold. By said non-uniform mass distribution about the object pivot point, said first and second bodies are configured to rotate about the object pivot point in a direction opposite to a direction of said rotational acceleration of the object exceeding a predefined or configurable first threshold when the actuator is coupled to the rotatable object. The coupling mechanisms enables numerous actions to be performed when the actuator is activated. The predefined or configurable first threshold allows a controlled and customized activation of the actuator.

In another embodiment of the actuator, the first and second bodies and the first and second coupling arrangements are in, or parallel to, a plane of rotation of the rotatable object. This is beneficial since it allows for a more compact design of the actuator.

In another embodiment of the actuator, the first and second bodies are configured to be arranged at radially opposite sides of the object pivot point. This is beneficial since it enables a design that is less sensitive to vibrations and allows for a more even distribution of the mass across the object. More specifically, the first and second bodies may be configured to be arranged such that the non-uniform mass distribution about their object pivot point cause rotational movement in or parallel to a plane of rotation, with respect to the first and second bodies, opposite directions about the object pivot point when the actuator is coupled to the rotatable object and the object is subjected to a force, directed in or parallel to the plane of rotation, which does not cause rotational acceleration of the object. The first and second bodies and the first and second coupling arrangements may be arranged to disable rotational movement about the object pivot point arising from one or more forces, directed in or parallel to the plane of rotation, which does not cause rotational acceleration of the object.

In another embodiment of the actuator, the first and second coupling arrangement and the first and second body are arranged such that the mass distribution of the actuator is uniform about the object pivot point when the actuator is coupled to the rotatable object. This is beneficial since it prevents introduction of imbalance in the rotatable object.

In another embodiment of the actuator, it further comprises fastening means configured to be attached to rotatable object, and the first and second coupling arrangement pivot points are provided on the fastening means. This is beneficial since it makes the actuator less sensitive to the influence of external forces such as gravitational forces. This is especially beneficial at comparably low rotational speeds of the object at which a centrifugal force acting upon the actuator may be lower than the gravitational force. More specifically, the first and second bodies and the first and second coupling arrangements may be arranged to disable rotational movement about the object pivot point arising from one or more forces, directed in or parallel to the plane of rotation, which does not cause rotational acceleration of the object.

In another embodiment of the actuator, it further comprises at least one braking means configured to engage, preferably by friction, an external object when the actuator is transitioned to an activated state. This is beneficial since it facilitates braking of the rotatable object in response to rotational acceleration of the object exceeding a predefined or configured threshold.

In another embodiment of the actuator, said at least one braking means is provided on at least one of the first and second coupling arrangements. Said at least one braking means may alternatively or additionally be provided at least one of the first and second bodies.

In another embodiment of the actuator, it further comprises at least one biasing arrangement arranged to transition the actuator from an activated state when the actuator is coupled to the rotatable object and the rotational acceleration of the object is below a predefined or configurable second threshold. This is beneficial since it allows the actuator to transition in and out of its activated state in a controlled manner. The biasing arrangement may for instance comprise a magnet. The biasing arrangement may be configured to engage magnetically with the rotational object. The predefined or configurable first threshold and the predefined or configurable second threshold are determined in part by the configuration of said at least one return biasing arrangement.

In another embodiment of the actuator, the actuator may be configured to delay the engagement of at least one of the first and second coupling arrangements by a hold off time, or “jerk control”. This is beneficial since it allows the removal or reduction of unwanted activation of the actuator.

In another embodiment of the actuator, the mass distribution of each coupling arrangement is uniform about each respective coupling arrangement pivot point. This is beneficial since it allows for a more even distribution of the mass across the object.

In another embodiment of the actuator, the mass distribution of each coupling arrangement is non-uniform about each respective coupling arrangement pivot point. This is beneficial since it allows for more flexibility in design and placement of the actuator.

In a second aspect, a rotatable object comprising an actuator is presented. The actuator is configured to be primarily activated by Euler forces arising from rotational acceleration of the rotatable object about an object pivot point of the rotatable object. The actuator comprises a first coupling arrangement and second coupling arrangement, each coupling arrangement being coupled to the rotatable object by a respective coupling arrangement pivot point. Each coupling arrangement comprises a first outer pivot point and a second outer pivot point radially offset from the coupling arrangement pivot point. The respective first outer pivot points are operatively coupled by a first body, and the respective second outer pivot points are operatively coupled by a second body, such that a center of mass of each body is radially offset from the object pivot point.

In one embodiment, the actuator is the actuator according to embodiments of the first aspect.

In another embodiment, the rotatable object is a clutch. This is beneficial since it enables e.g. the removal or addition of drive to the rotational object or any other suitable body.

In another embodiment, the rotatable object is a brake. This is beneficial since it enables braking force applied to the rotational object or any other suitable body.

### BRIEF DESCRIPTION OF THE DRAWINGS

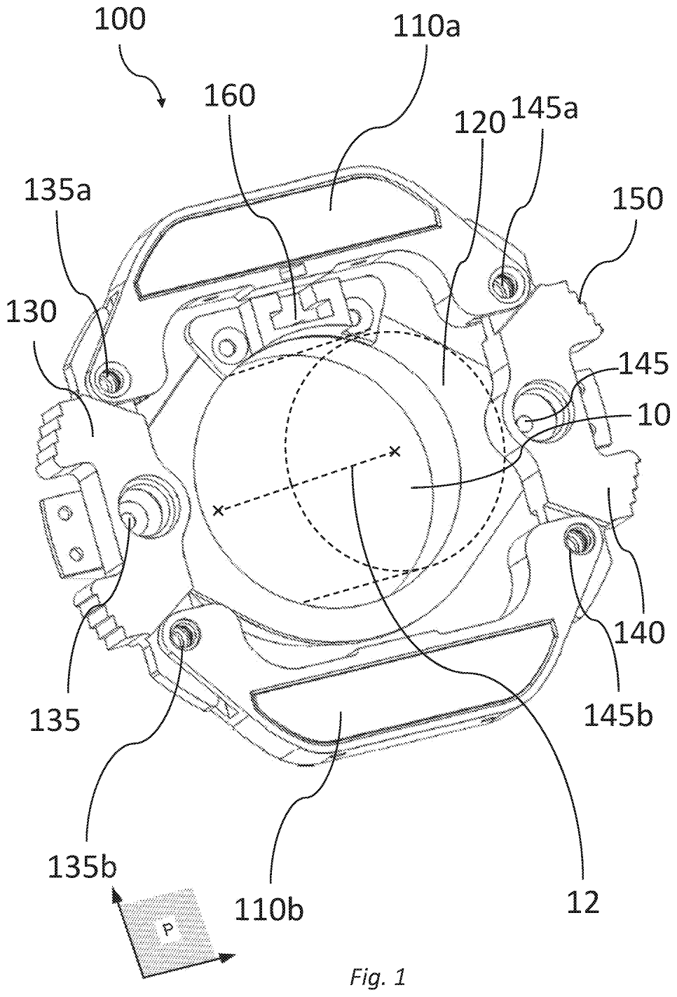

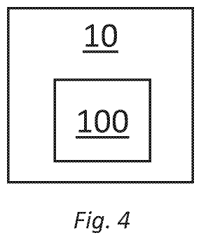

By way of example, embodiments of the present invention will now be described with reference to the accompanying drawings, in which FIGS. 1, 2 and 3 are schematic views of an actuator according to some embodiments of the invention and FIG. 4 is a schematic view of a rotatable object according to some embodiments of the invention.

### DETAILED DESCRIPTION

Hereinafter, certain embodiments will be described more fully with reference to the accompanying drawings. Aspects of this disclosure may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. The terms “a” and “an” are defined as one or more unless this disclosure explicitly requires otherwise. The terms “substantially”, “approximately” and “about” are defined as largely, but not necessarily wholly what is specified, as understood by a person of ordinary skill in the art. The terms “comprise”, “have”, “include”, “contain” and their respective forms, are open-ended linking verbs. As a result, a device that “comprises,” “has,” “includes” or “contains” one or more particular steps, possesses those one or more steps, but is not limited to possessing only those particular one or more steps.

The term acceleration is, when used throughout this disclosure, defined as acceleration and/or deceleration. In other words, the acceleration may be positive or negative and the teachings of this disclosure applies in either case. Further to this, the term rotational acceleration is in this disclosure defined to be equal to an angular acceleration and may, as mentioned above, be both positive and negative.

With reference to FIGS. 1, 2 and 3, an actuator 100 for coupling to a rotatable object 10 will be described. The rotatable object 10, or simply object 10 for short, may be embodied in many different forms, such as, but not limited to, an axle, a bar, a shaft, a rod, a wheel. The object 10 is rotatable about an object pivot point 12. The object 10 may be rotated in, or parallel to a plane of rotation P. The rotation may be clockwise or anti-clockwise. Any real or hypothetical point at, on, or in the rotatable object 10 will rotate with the object 10 about the object pivot point 12. An angular velocity of rotation of the object 10 will be the same as an angular velocity of the real or hypothetical point. However, as is well known, the rotational speed in a tangential direction, i.e. a tangential speed, will depend on a distance from the object pivot point 12 to a point where the tangential speed is determined. When the object 10 is rotating with a constant angular velocity, i.e. an angular acceleration of the object 10 is zero, the rotation will give rise to a radial centrifugal force on the point but no tangential force will occur from rotation with constant angular velocity. However, when the angular velocity changes, i.e. the absolute value of the angular acceleration of the object 10 is greater than zero, the acceleration will give rise to a tangential force commonly known as the Euler force arising from Euler acceleration. The Euler acceleration may also be known as azimuthal acceleration or transverse acceleration. These names, Euler, transverse and azimuthal, may be used interchangeably throughout this disclosure and are understood by the skilled person to be interpreted as the same force or acceleration. The Euler force is known from the art as a fictitious tangential force acting on a body with a mass m at a distance r from the center of rotation 12 of the object 10. The Euler force FE may be calculated from the transverse acceleration ar of the angular velocity @ as detailed in the equation below:

$${F}_{E} = - m \times {\overline{a}}_{T} = - m \cdot \frac{δω}{δ t} \times \overline{r}$$

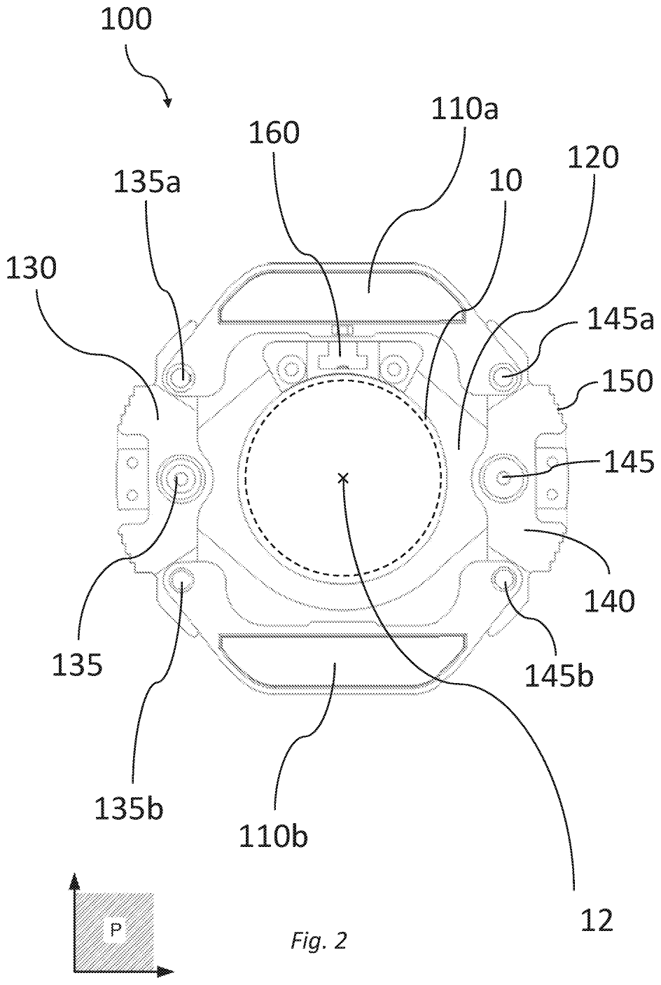

The actuator 100 as illustrated in FIGS. 1 and 2 is configured to be primarily activated by transversal acceleration arising from rotational acceleration of the rotatable object 10 about an object pivot point 12 of the rotatable object 10. That is to say, the actuator 100 is configured to be primarily activated by Euler forces arising from rotational acceleration of the rotatable object 10. In other words, the actuator is primarily activated by Euler acceleration. The actuator 100 comprises a first coupling arrangement 130 and second coupling arrangement 140, each coupling arrangement 130, 140 being configured to be pivotally coupled to the rotatable object 10 by a respective coupling arrangement pivot point 135, 145. Such a coupling may be accomplished by a pin fixed to the rotatable object 10 and inserted into a hole or crevice at the respective coupling arrangement pivot point 135, 145. It may very well be a coupling utilizing e.g. bearing to reduce friction. Each coupling arrangement 130, 140 may additionally, or alternatively be coupled, at the respective coupling arrangement pivot point 135, 145, to a fastening means 120 which is in turn attached to the object 10. That is to say, the coupling arrangements 130, 140 are coupled to the rotatable object 10 via the fastening means 120. The fastening means 120 may be configured to be attached to the rotatable object 10, and the first and second coupling arrangement pivot points 135, 145 may be provided on the fastening means 120. The fastening means 120 may e.g. comprise a plate or a housing. The fastening means 120 may be configured to be attached to the rotatable object 10 in any suitably way. In one embodiment, the fastening means 120 is configured to be arranged around the rotatable object 10 similarly to a hose clamp.

Each coupling arrangement 130, 140 comprises a first outer pivot point 135a, 145a and a second outer pivot point 145a, 145b radially offset from the coupling arrangement pivot point 135, 145. The respective first outer pivot points 135a, 145a are operatively coupled by a first body 110a, and the respective second outer pivot points 135b, 145b are operatively coupled by a second body 110b, such that the mass distribution of each body 110a, 110b is non-uniform about the object pivot point 12 when the actuator 100 is coupled to the rotatable object 10. As discussed above, such a coupling may be achieved in numerous suitable ways. In some examples, a center of mass of at least one of the bodies 110a, 110b is radially offset from the object pivot point 12. Advantageously, the center of mass of each of the bodies 110a, 110b is radially offset from the object pivot point 12.

As also discussed above, any rotating body will experience the Euler force when subjected to angular acceleration. Further, any rotating body having a mass distribution that is non-uniform about its body pivot point may be used to activate an activator 100 by the Euler force. The first and second bodies 110a, 110b, having a non-uniform mass distribution about its body pivot point, may therefore also be referred to as Euler bodies. The mass of Euler bodies, and thus the first and second bodies 110a, 110b, is non-uniformly distributed about their respective pivot points 12. It may be said that the bodies 110a, 110b are to be formed such that their respective center of mass is offset from the body pivot point 12. A mass of the bodies 110a, 110b is distributed such that a first region of the body radially distanced from the body pivot point 12 exhibit a different mass compared to a corresponding second region at the same radial distance but rotated relative to the first region. It should be mentioned that, seeing as each of the bodies 110a, 110b are connected to both coupling arrangements 130, 140, the resulting assembly of the coupling arrangements 130, 140 and bodies 110a, 110 will have a non-uniform mass distribution at least about the coupling arrangement pivot point 135, 145.

The non-uniform mass distribution of the first and second bodies 100a, 100b about the body pivot point 12 may be fixed or dynamic due to e.g. flexibility of the bodies 110a, 110b. There may be liquid inside the bodies 110a, 110b such that the mass distribution is changed by e.g. centrifugal forces. Further to this, there may be elasticity in the design of the bodies 110a, 110b. All suitable particulars and derivatives of this definition are considered when referencing the bodies 110a, 110b. It should be noted that the illustrated shape of the first and second bodies 110a, 110b are merely examples. The outline of the bodies 110a, 110b is not limited to any particular forms or shapes, but any suitable body having a non-uniform distribution of mass about its associated object pivot point is covered by this description.

The actuator 100 may, due to said non-uniform mass distribution about the object pivot point 12, be configured to transition to an activated state, by said first and second bodies 110a, 110b rotating about the object pivot point 12, in response to rotational acceleration of the object 10 exceeding a predefined or configurable first threshold, wherein said first and second bodies 110a, 110b are configured to rotate about the object pivot point 12 in a direction opposite to a direction of said rotational acceleration of the object 10 exceeding a predefined or configurable first threshold when the actuator 100 is coupled to the rotatable object 10. In other words, when activated, said first and second bodies 110a, 110b rotate about the object pivot point 12 in a direction opposite the rotational acceleration of the object 10. The first threshold may be related to a biasing arrangement 160 arranged to lock the bodies 110a, 110b into a first position. As the acceleration of the bodies 110a, 110b overcomes the force with which the biasing element locks the bodies 110a, 110b in the first position, the bodies 110a, 110b are permitted to transition to a second position. The amount of angular acceleration of the object 10 that is required to transition the bodies 110a, 110b to the second position may be defined as a first threshold. The first and second bodies 110a, 110b may be affected by other forces than the Euler force. Such forces may be gravitational forces, centrifugal forces or virtually any force acting on the bodies 110a, 110b in the plane of rotation P towards or from the object pivot point 12. Forces in the plane of rotation P directed in other directions will have components causing rotation, or a change in rotation of the object 10 and consequently transversal acceleration of the bodies 110a, 110b. By the bodies 110a, 110b being configured to an activated state in response to rotational acceleration of the object 10 exceeding a predefined or configurable first threshold, the effect of the non-Euler forces acting on the bodies 110a, 110b is reduced.

The biasing arrangement 160 may comprise a friction element, a biasing element, a magnetic element, an electromagnetic element etc. The first threshold may be configurable and/or predetermined, e.g. by controlling an electromagnetic force of the biasing arrangement 160.

The biasing arrangement 160 may be arranged to transition the actuator 100 from an activated state when the actuator 100 is coupled to the rotatable object 10 and the rotational acceleration of the object 10 is below a predefined or configurable second threshold. The biasing arrangement 160 may be formed into two parts such that the rotation of the object 10 will engage one of the parts upon rotation in one direction, and the other of the parts upon rotation in the other direction. This may effectively be used to have different second thresholds depending on the direction of rotation of the bodies 110a, 110b.

The actuator 100 may further be configured to delay the engagement of the first and second coupling arrangements 130, 140 by a hold off time. The hold off time may be relating to the amount by which the transversal acceleration exceeds the first threshold. Alternatively, or additionally, the hold off time may be relating to the time the angular acceleration of the object 10 has to exceed the first threshold before the actuator 100 is activated. The hold off time allows the actuator 100 to be set with a high sensitivity, i.e. a low first threshold, while still reducing the risk of undesired activation of the actuator 100. In other words, the actuator 100 may be provided with a jerk control.

In FIGS. 1, 2 and 3, the first and second bodies 110a, 110b are arranged at radially opposite sides of the object pivot point 12. In this arrangement, the non-uniform mass distribution about the object pivot point 12 causes rotational movement in or parallel to the plane of rotation P, with respect to the first and second bodies 110a, 110b, in opposite directions about the object pivot point 12 when the actuator 100 is coupled to the rotatable object 10 and the object 10 is subjected to a force, directed in or parallel to the plane of rotation P, which does not cause rotational acceleration of the object 10. The actuator 100 of FIGS. 1 and 2 may be arranged about the object pivot point 12. The rotatable object 10 may extend through an area described by the first and second bodies 110a, 110b and the first and second coupling arrangements 130, 140. The first and second bodies 110a, 110b and the first and second coupling arrangements 130, 140 may be configured to surround (encircle, compass, embed, embrace, encompass) the rotatable object 10.

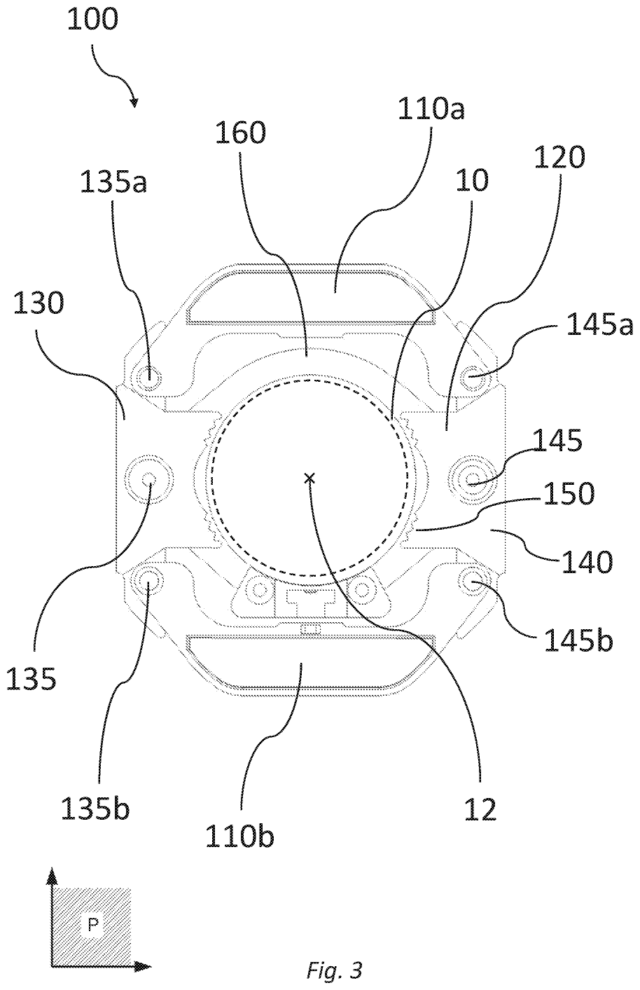

The actuator 100 as illustrated in the figures comprises at least one braking means 150 configured to frictionally engage an external object (not shown) when the actuator 100 is transitioned to an activated state, such that e.g. a current rotational speed of the object 10 is changed. The external object may be embodied in many different forms, such e.g. a drum. The external object may at least partly enclose the actuator, and the braking means 150 may be provided on the outside of the actuator 100, as shown in FIGS. 1 and 2. Alternatively or additionally, the braking means 150 may be provided on the inside of the actuator, directed towards the center of rotation of the rotational object 10 as shown in FIG. 3. In this case, the external object may at least partly be enclosed by the actuator. The external object may be configured to not rotate with the rotational object 10, or at least not rotate with the same angular velocity as the rotational object. By the braking means 150 (frictionally) engaging with the external object, the angular velocity of the rotating object 10 may be reduced. This is beneficial as it enables the rotational speed of an object 10 to be reduced when an acceleration of the object 10 exceeds a first threshold. In an alternative embodiment, the external object may rotate at a wanted speed and as the braking means 150 (frictionally) engage the external object, the rotating object 10 is effectively accelerated. This may be beneficial when unwanted decelerations are to be avoided in e.g. transmissions etc. The at least one braking means 150 may be provided on at least one of the first and second coupling arrangements 130, 140, and/or at least one of the first and second bodies 110a, 110b.

The mass distribution of one or each coupling arrangement 130, 140 may be uniform about each respective coupling arrangement pivot point 135, 145. The mass distribution of one or each coupling arrangement 130, 140 may be non-uniform about each respective coupling arrangement pivot point 135, 145.

The first and second coupling arrangement 130, 140 and the first and second body 110a, 110b may be arranged such that the mass distribution of the actuator 100 is uniform about the object pivot point 12 when the actuator 100 is coupled to the rotatable object 10. It may be desirable to place the actuator 100 uniformly about the object pivot point 12 in order not to introduce imbalance in the rotatable object 10.

A second aspect is illustrated in FIG. 4. FIG. 4 schematically illustrates a rotatable object 10 comprising the actuator 100 according to any embodiment, aspect or example as presented herein.

Embodiments of the second aspect will now be briefly described. In one embodiment, the rotatable object 10 as illustrated in FIG. 4 is a clutch. The clutch enables e.g. the removal or addition of drive to the rotational object 10 when accelerated. In another embodiment, the rotatable object 10 as illustrated in FIG. 4 is a brake. The brake enables braking force being applied to the rotational object 10 when accelerated. The brake may as an example be provided on a walker. If a person using the walker should stumble and start falling, the actuator 100 of the brake may be arranged to activate a coupling arrangement 130, 140 comprising braking means 150. This will allow the walker to stop and the person may regain her balance without falling.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference to braking or coupling, persons skilled in the art will appreciate that the embodiments of the invention can equivalently be applied to combinations of these and many other areas. Further examples illustrating the shape and form of the actuator are exemplary and the invention can equivalently be applied to any other shapes form or arrangement comprising the generic features of the invention. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. An actuator for coupling to a rotatable object, the actuator being configured to be primarily activated by Euler forces arising from rotational acceleration of the rotatable object about an object pivot point of the rotatable object, the actuator comprising a first coupling arrangement and second coupling arrangement, each coupling arrangement being configured to be pivotally coupled to the rotatable object by a respective coupling arrangement pivot point,
wherein each coupling arrangement comprises a first outer pivot point and a second outer pivot point radially offset from the coupling arrangement pivot point,
wherein the respective first outer pivot points are operatively coupled by a first body, and the respective second outer pivot points are operatively coupled by a second body, such that a center of mass of each body is radially offset from the object pivot point when the actuator is coupled to the rotatable object.

2. The actuator according to claim 1, wherein, due to said non-uniform mass distribution about the object pivot point, the actuator is configured to transition to an activated state, by said first and second bodies rotating about the object pivot point, in response to rotational acceleration of the object (10) exceeding a predefined or configurable first threshold.

3. The actuator according to claim 1, wherein the first and second bodies and the first and second coupling arrangements are configured to be arranged in, or parallel to, a plane of rotation (P) of the rotatable object.

4. The actuator of claim 1, wherein the first and second bodies (100a, 100b) are configured to be arranged at radially opposite sides of the object pivot point (12).

5. The actuator of claim 1, wherein the first and second coupling arrangement and the first and second body are arranged such that a mass distribution of the actuator is uniform about the object pivot point when the actuator is coupled to the rotatable object.

6. The actuator of claim 1, further comprising a fastening means configured to be attached to the rotatable object, wherein the first and second coupling arrangement pivot points are provided on the fastening means.

7. The actuator of claim 1, further comprising at least one braking means configured to engage an external object when the actuator is transitioned to an activated state.

8. The actuator of claim 7, wherein said at least one braking means is provided on at least one of the first and second coupling arrangements.

9. The actuator of claim 7, wherein said at least one braking means is provided on at least one of the first and second bodies.

10. The actuator of claim 1, further comprising at least one biasing arrangement arranged to transition the actuator from an activated state when the actuator is coupled to the rotatable object and the rotational acceleration of the object is below a predefined or configurable second threshold.

11. The actuator of claim 1, wherein a mass distribution of each coupling arrangement is uniform about each respective coupling arrangement pivot point.

12. The actuator of claim 1, wherein a mass distribution of each coupling arrangement is non-uniform about each respective coupling arrangement pivot point.

13. A rotatable object comprising an actuator, the actuator being configured to be primarily activated by Euler forces arising from rotational acceleration of the rotatable object about an object pivot point of the rotatable object, the actuator comprising a first coupling arrangement and second coupling arrangement, each coupling arrangement being pivotally coupled to the rotatable object by a respective coupling arrangement pivot point,
wherein each coupling arrangement comprises a first outer pivot point and a second outer pivot point radially offset from the coupling arrangement pivot point,
wherein the respective first outer pivot points are operatively coupled by a first body, and the respective second outer pivot points are operatively coupled by a second body, such that a center of mass of each body is radially offset from the object pivot point.

14. The rotatable object of claim 13, wherein the actuator is the actuator according to claim 2.

15. The rotatable object of claim 13, wherein the actuator is a clutch.

16. The rotatable object of claim 13, wherein the actuator is a brake.
